(19) United States
(12) Patent Application Publication
(10) Pub. No.: US 2007/0094338 A1
(43) Pub. Date: Apr. 26, 2007

(54) SYSTEM FOR TRANSMITTING AN ELECTRONIC MESSAGE

(75) Inventor: Nathan John Kirkham, Hants (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/463,106

(22) Filed: Aug. 8, 2006

(30) Foreign Application Priority Data
Aug. 13, 2005 (GB) 0516672.3

(51) Int. Cl. G06F 15/16

(52) U.S. Cl. 709/206

(57) ABSTRACT

A system for transmitting an electronic message, wherein the electronic message is generated by a first entity utilizing an electronic messaging application, the system comprising: an input detector for detecting a first input to the electronic message from the first entity, wherein the first input is associated with a first address of a second entity; a weight component for determining first weight data associated with the first input; and an instruction generator, for generating an instruction associated with transmission of the electronic message to the second entity in accordance with the first weight data.

### FIELD OF THE INVENTION

The present invention relates to a system for transmitting an electronic message.

### BACKGROUND OF THE INVENTION

Electronic messaging systems (e.g. e-mail, instant messaging) are currently widely used.

However, a sender can inadvertently send a message to an incorrect recipient, for example, by inputting an incorrect e-mail address, which can cause disclosure of inappropriate (e.g. confidential or personal) information.

A current solution to this problem is a retrieval mechanism (e.g. used in some e-mail systems) that retrieves an input message that has been marked for sending by a sender, but that is yet to be sent (e.g. via an Internet Service Provider (ISP) and e-mail server) to the recipient. However, with this mechanism, the onus is on the sender to notice that a message is marked to be sent to an incorrect recipient and also to invoke the retrieval mechanism.

### SUMMARY OF THE INVENTION

According to a first aspect, the present invention provides a system for transmitting an electronic message, wherein the electronic message is generated by a first entity utilizing an electronic messaging application, the system comprising: an input detector for detecting a first input to the electronic message from the first entity, wherein the first input is associated with a first address of a second entity; a weight component for determining first weight data associated with the first input; and a instruction generator, for generating an instruction associated with transmission of the electronic message to the second entity in accordance with the first weight data.

Preferably, the instruction is associated with the first address. More preferably, the system further comprises a comparator for comparing the first input with a storage component comprising data in order to derive a second input associated with a second address of a third entity. Still more preferably, the comparator matches the first input to the data.

In a preferred embodiment, the weight component determines second weight data associated with the second input. Preferably, the instruction generator ranks the first weight data and the second weight data in order to select one of the first weight data and the second weight data. More preferably, the instruction generator generates the instruction in accordance with the selected weight data. Still more preferably, the instruction generator transmits the instruction to the electronic messaging application. Still more preferably, the instruction generator compares at least one of: the first weight data and the second weight data with a threshold, in order to generate the instruction.

According to a second aspect, the present invention provides a method for transmitting an electronic message, wherein the electronic message is generated by a first entity utilizing an electronic messaging application, the method comprising the steps of: detecting a first input to the electronic message from the first entity, wherein the first input is associated with a first address of a second entity; determining first weight data associated with the first input; and generating an instruction associated with transmission of the electronic message to the second entity in accordance with the first weight data.

According to a third aspect, the present invention provides a computer program product comprising machine readable media embodying program code that, when executed on a computer, results in the computer performing the method described above.

### BRIEF DESCRIPTION OF THE DRAWINGS

The present invention will now be described, by way of example only, with reference to preferred embodiments thereof, as illustrated in the following drawings:

FIG. 1 is a schematic diagram of a distributed data processing system in which the present invention may be implemented;

FIG. 2 is a more detailed schematic diagram of the first data processing system comprising an electronic messaging application shown in FIG. 1; and

FIG. 3 is a flow chart showing the operational steps involved in a process according to one preferred embodiment; and

FIG. 4 is a flow chart showing the operational steps involved in a process according to another preferred embodiment.

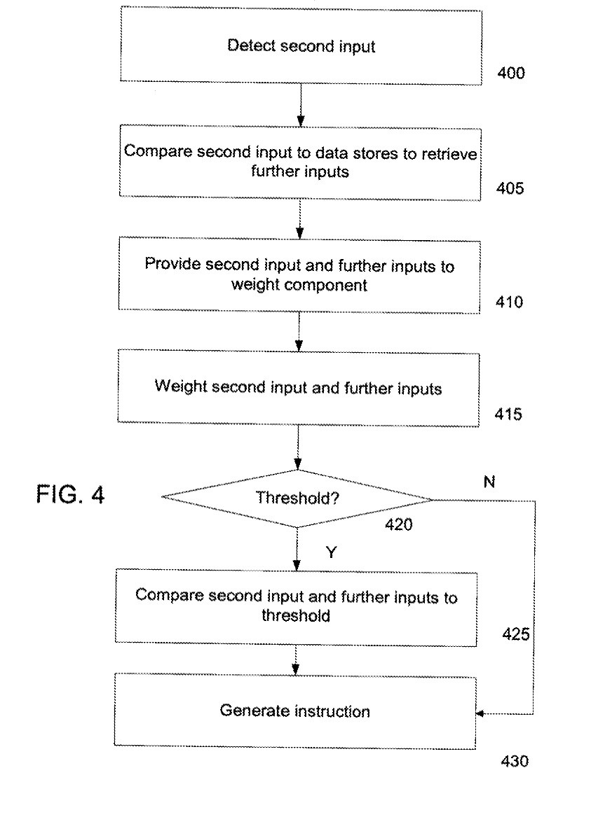

### DETAILED DESCRIPTION

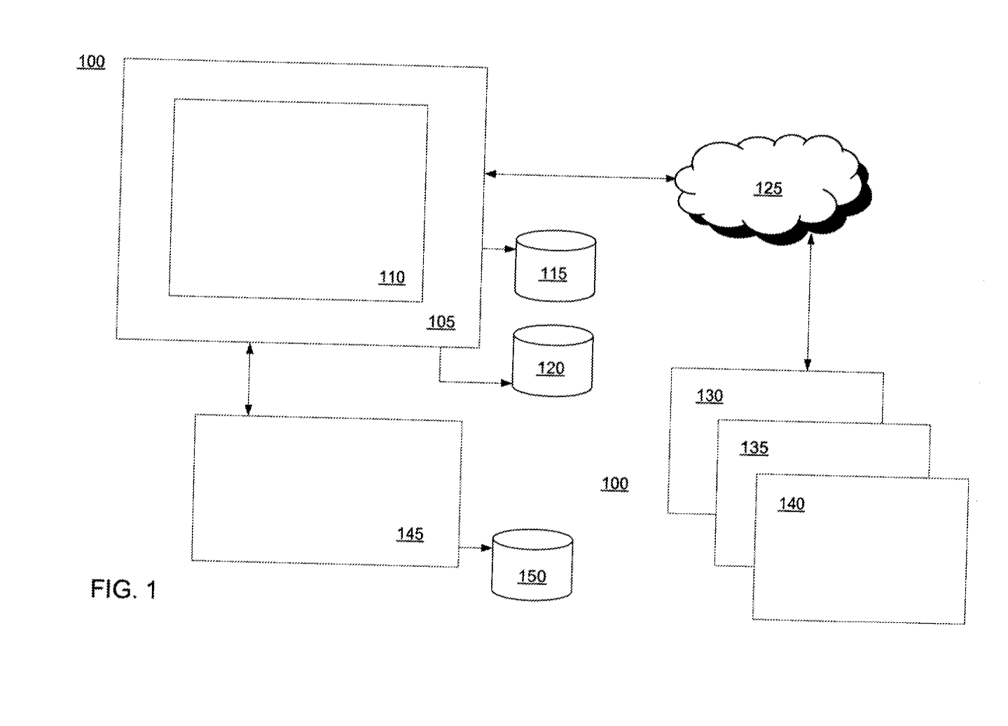

FIG. 1 is a schematic diagram of a distributed data processing system (100) in which the present invention may be implemented. There is shown a first data processing system (105) comprising an electronic messaging application (110) (e.g. an e-mail application, an instant messaging application etc.). In the examples described herein, the electronic messaging application (110) is an e-mail application.

The first data processing system (105) is also associated with a local first storage component (115) and a local second storage component (120). In the description herein, the first storage component (115) comprises data associated with an input from a first user and the second storage component (120) comprises data associated with one or more weights.

Preferably, the first data processing system (105) is also associated with a remote server (145) comprising a third storage component (150) comprising data associated with an input from the first user.

Typically, the first user utilizes the electronic messaging application (110) to create an e-mail targeted to a recipient. The e-mail is typically sent via the first user's Internet Service Provider (ISP) and e-mail provider via a network (125), via the recipient's ISP and e-mail provider to the recipient's data processing system. Data processing systems (130, 135 and 140) of further users are shown in FIG. 1.

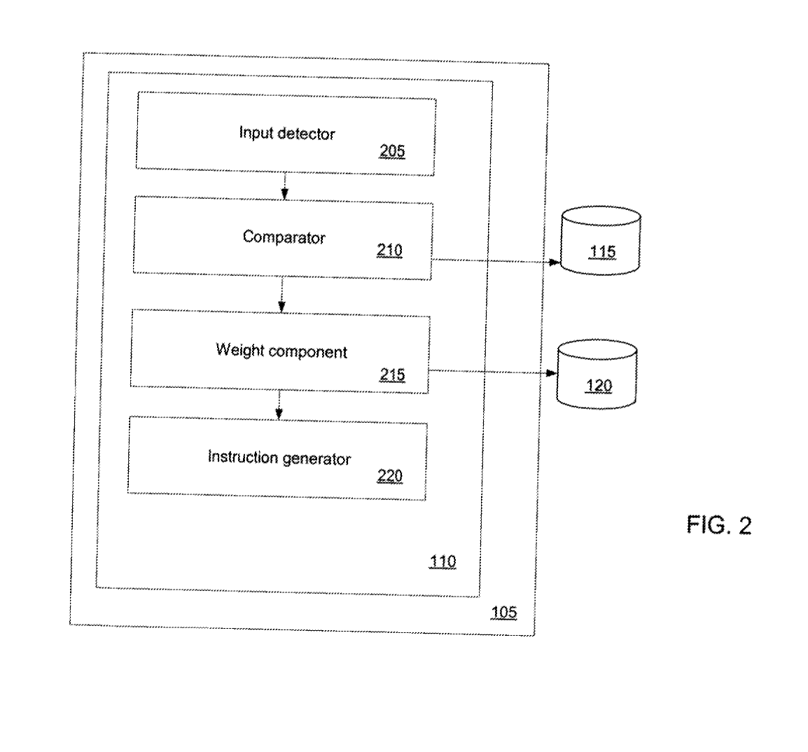

FIG. 2 is a more detailed schematic diagram of the first data processing system (105), wherein the first data processing system (105) comprises an input detector (205), a comparator (210) associated with the first storage component (115), a weight component (215) associated with the second storage component (120) and an instruction generator (220).

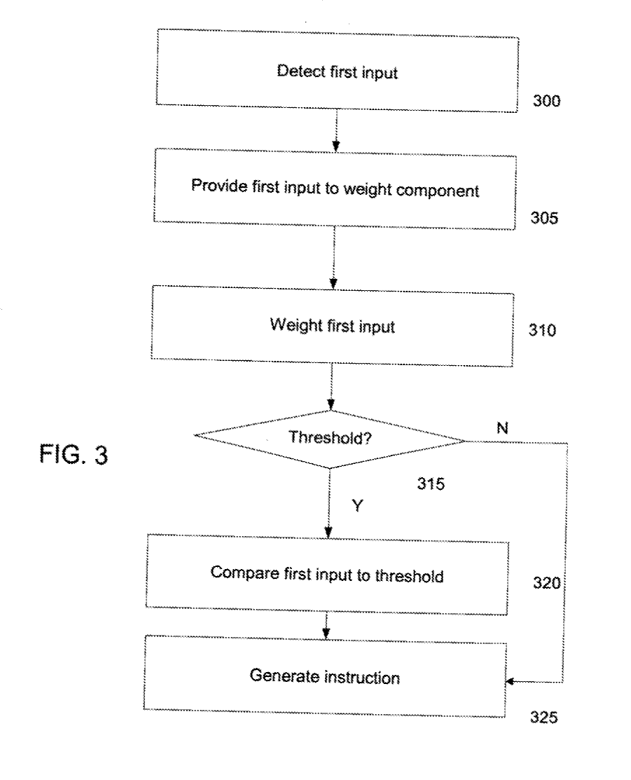

The preferred embodiment will now be described with reference to FIGS. 1-3. A first user utilizes the electronic messaging application (110) to create an e-mail. In response to the instantiation of an e-mail, the input detector (205) is invoked. Preferably, the input detector (205) is configurable to detect (step 300) (e.g. using a typical parse function) one or more input types. For example, an input type comprises an e-mail address associated with a recipient, typically inputted to a particular field in the e-mail. In another example, an input type comprises textual content associated with the body of the e-mail itself. The input detector (205) can be configurable to be invoked in response to: detection of partial input, manual invocation from the first user, a time threshold being met etc.

In a first example, a first input is detected, wherein the input type of the first input comprises an e-mail address (e.g. John_Smith@uk.company.com).

The input detector (205) provides (step 305) the first input to the weight component (215). The weight component (215) utilizes the second storage component (120) comprising data associated with weights in order to assign (step 310) weight data to the first input.

A representation of the second storage component (120) is shown below in Table 1, comprising elements associated with a geography in an e-mail address and an associated weight (as a percentage):

TABLE 1

| Geography | Weight (%) |
|---|---|
| UK | 50 |
| DE | 80 |

The weight component (215) compares the geography of the first input against the second storage component (120) and finds an entry in the second storage component (120). The weight component (215) reads the associated weight data in order to assign weight data (step 315) to the first input. In response to the weighting step, the first input is associated with a weight of 50% (because the associated geography, is UK). The weight component (215) provides the first input and associated weight data to the instruction generator (220).

At step 315, the instruction generator (220) determines whether a threshold associated with an instruction has been configured. In response to a threshold associated with an instruction being configured, the instruction generator (220) compares (step 320) the weight data associated with the first input to the threshold (e.g. a pre-configured threshold set by a user, an administrator, a system etc.), in order to determine an instruction associated with sending of the e-mail. In the first example, the instruction generator (220) compares the weight data against the following threshold, wherein the threshold >=25% is associated with an instruction to automatically send the e-mail created by the first user to the recipient associated with the e-mail address of the first input:

| Threshold | Instruction |
|---|---|
| >=25% | Send e-mail |

In the first example, the instruction generator (220) determines that the weight data associated with the first input meets the threshold and reads (step 325) the associated instruction (i.e. “send e-mail”). Next, the instruction generator (220) sends the instruction to the electronic messaging application (110) for sending in the usual way, to the e-mail address associated with the first input.

With reference to step 315, in response to a threshold associated with an instruction not being configured, step 325 is executed, wherein the instruction generator (220) reads a pre-configured instruction (e.g. “send e-mail”) associated with weight data and sends the instruction to the electronic messaging application (110).

Advantageously, if an e-mail address is associated with weight data, and an appropriate instruction is associated with the weight data, an e-mail can be transmitted to the most appropriate recipient. For example, if in the first example, a geography associated with the first user is “DE”, since a higher weight is associated with a geography in an e-mail address of DE, an instruction to automatically send the e-mail to an e-mail address comprising a geography of DE can be associated with the e-mail address.

In a second example, a first user utilizes the electronic messaging application (110) to create an e-mail. In response to the instantiation of an e-mail, the input detector (205) is invoked. The input detector (205) detects (step 400) a second input, wherein the input type of the second input comprises an e-mail address (e.g. John_Smith@uk.company.com).

The input detector (205) provides (step 410) the second input to the weight component (215). The second input is weighted (step 415) using Table 1, resulting in the second input having an associated weight data of 50%. The second input and the associated weight data are provided to the instruction generator (220).

In response to the detecting step, the comparator (210) compares (step 405) the second input to one or more storage components, in order to determine further inputs that are alternatives to the second input.

In the second example, the comparator (210) compares the second input to the first storage component (115). The first storage component (115) comprises data associated with the second input.

In the second example, the data in the first storage component (115) comprises: 1) a “sent” log of e-mail addresses associated with recipients of e-mails from the first user; and 2) the first user's local address book comprising e-mail addresses (and optionally, names, contact telephone numbers etc.) of users.

In the second example, the second input is also transmitted to the remote server (145) and the comparator (210) compares the second input to the third storage component (150). Alternatively, a comparator (not shown) residing on the remote server (145) can compare the second input to the third storage component (150). The third storage component (150) comprises data associated with the second input.

In the second example, the data in the third storage component (150) comprises a global address book comprising e-mail addresses of users. The users can be associated with the first user; e.g. users associated with the first user's organization, etc.

It should be understood that the first storage component (115) and the third storage component (150) can comprise a number of types of data. For example, the data can comprise skill data (e.g. skill=hardware; skill=software etc.) associated with users and e-mail addresses associated with those users. In another example, the data can comprise an organization chart associated with users, comprising e-mail addresses of those users.

An example of a comparator function executed by the comparator (210) is a match function which determines whether an exact match or substantial match to the second input is present in the one or more storage components. In the second example, the second input John_Smith@uk.company.com is matched to e-mail addresses in the first storage component (115) and third storage component (150) (i.e. the “sent” log of e-mail addresses, the first user's local address book, the global address book etc.) to determine whether an exact match is present (i.e. John_Smith@uk.company.com) or whether a substantial match is present (e.g. John.Smiths@company.com). This allows further inputs that are alternatives to the second input to be determined.

The match function can be augmented by analyzing a name included in an input comprising an e-mail address in order to determine a further set of inputs that can be matched to e-mail addresses in the one or more storage components. For example, a further set of inputs can be determined by using the input to fuzzy search a database of name data in order to derive further names; executing phonetic analysis in order to derive further names etc. Once further names are derived (e.g. John Smyths), the names can be matched to e-mail addresses in the one or more storage components. This allows further inputs that are alternatives to the input to be determined.

In another example, an input comprising textual content associated with the body of the e-mail itself (e.g. “Please explain the error in the hardware”) can be matched to textual data associated with skill data of users to determine whether an exact match is present (i.e. “hardware”) or whether a substantial match is present (e.g. “hard disk drives”). Any match is then associated with an e-mail address of that user.

In yet another example, an input comprising an e-mail address is matched to an organization chart comprising e-mail addresses in order to determine further inputs that are alternatives to the input.

In the second example, in response to the comparator (210) comparing the second input to the first storage component (115) and the third storage component (150), the following further inputs are determined:
Input 1—John_Smith@company.com; source—global address book
Input 2—John.Smiths@company.com; source—sent log
Input 3—Johnathan_Smithson@company.com; source—global address book

The comparator (210) provides (step 310) the further inputs and the source(s) of the further inputs to the weight component (215).

The weight component (215) utilizes the second storage component (120) comprising data associated with weights in order to assign (step 415) weight data to each of the further inputs.

A representation of the second storage component (120) is shown below in Table 2, comprising elements associated with an input source and an associated weight (as a percentage):

TABLE 2

| Input Source | Weight (%) |
|---|---|
| Global address book | 50 |
| Sent log | 80 |

The weight component (215) compares the source of the further inputs against the second storage component (120) and finds entries in the second storage component (120). The weight component (215) reads the associated weight data in order to assign weight data (step 315) to Input 1 Input 2 and Input 3. In response to the weighting step, Input 1 is associated with a weight of 50% (because the associated input source is a global address book), Input 2 is associated with a weight of 80% (because the associated input source is a “sent” log) and Input 3 is associated with a weight of 50% (because the associated input source is a global address book).

Preferably, the weight component (215) provides the further inputs and associated weight data to the instruction generator (220).

Preferably, the instruction generator (220) ranks the inputs (i.e. the second input, Input 1, Input 2 and Input 3) according to the associated weight data (i.e. 50%, 50%, 80% and 50% respectively) in order to select an input. In the second example, the instruction generator (220) selects an input with a highest associated weight (i.e. Input 2, with a weight of 80%).

At step 420, the instruction generator (220) determines whether a threshold associated with an instruction has been configured. In response to a threshold associated with an instruction being configured, the instruction generator (220) compares (step 425) the weight associated with Input 2 against one or more thresholds (e.g. a pre-configured threshold set by a user, an administrator, a system etc.), in order to determine an instruction associated with sending of the e-mail. In the second example, the instruction generator (220) compares the weight against the following thresholds, wherein: the threshold >=75%-100% is associated with an instruction to automatically send the e-mail created by the first user to the recipient associated with the e-mail address of Input 2 (i.e. the further input overrides the second input provided by the first user); the threshold >=50%-74% is associated with an instruction to notify the first user (e.g. wherein the notification requests confirmation to send the e-mail to the recipient associated with the e-mail address of Input 2—wherein a user can confirm or decline); the threshold >=0%-49% is associated with an instruction to display a list of options comprising the e-mail addresses of Input 1, Input 2 and Input 3 and preferably, the second input, wherein a user can select an e-mail address from the list:

| Threshold | Instruction |
|---|---|
| >=75%-100% | Send e-mail |
| >=50%-74% | Notify user |
| >=0%-49% | Display options |

In the second example, the instruction generator (220) determines that the weight associated with Input 2 falls within the threshold >=75%-100% and reads (step 430) the associated instruction (i.e. “send e-mail”). Next, the instruction generator (220) sends the instruction to the electronic messaging application (110) for sending in the usual way, to the e-mail address associated with Input 2.

With reference to step 420, in response to a threshold associated with an instruction not being configured, step 430 is executed, wherein the instruction generator (220) reads a pre-configured instruction (e.g. “send e-mail”) associated with weight data and sends the instruction to the electronic messaging application (110).

It should be understood that if an input is associated with a plurality of sources (i.e. wherein each source has an associated weight), a formula for calculating a total weight is applied by the weight component (215). In one embodiment, a formula which divides the sums of the weights by the total sum of all weights is applied. In another embodiment, a formula which averages the weights is applied. The formula can be generated by a systems administrator, a user, a system etc.

It should be understood that the weight data can be generated in a number of ways. For example, the weight data can be generated manually by a system administrator or a user (e.g. a user who is sending a message). Alternatively, the weight data can be generated automatically, for example, by monitoring a sending user's e-mail interactions.

For example, when an input comprising an e-mail address of a recipient is compared to an organization chart, a match function is executed in order to determine whether the e-mail address of the first user and the e-mail address of the recipient are found. If they are found, a tree walker function is executed in order to determine a distance between a node associated with the first user and a node associated with the recipient. Then for example, a greater weight value can be associated with a recipient having a node that is nearer in distance to the node associated with the first user on the organization chart.

In another example, when an input comprising an e-mail address of a recipient is compared to a “sent” log of e-mails, if a match is found, all “sent” e-mails associated with the matching e-mail address are retrieved. Next, a counter counts the number of e-mails retrieved or alternatively, an analyzer analyzes timestamp data associated with the e-mails. Then for example, a greater weight value can be associated with a particular recipient that has been e-mailed more frequently by the first user.

In yet another example, a decision from a user, for example, wherein a user confirms/declines a notification that requests a decision to send an e-mail to a recipient associated with a particular e-mail address or wherein a decision is associated with selection of a particular e-mail address from a list of options comprising a plurality of e-mail addresses can be used to update weight data. For example, the number of decisions that result in sending of e-mails to a particular recipient can be counted or timestamp data associated with the decisions can be analyzed. Then for example, a greater weight can be associated with a particular recipient that has been e-mailed frequently due to one or more decisions.

In yet another example, when an input comprising an e-mail address of a recipient is compared to a storage component, any resulting match is further analyzed in order to determine a geography associated with a work place of the recipient. A further comparison is executed of the recipient's geography with the first user's geography. Then for example, a greater weight value can be associated with a recipient having the same geography as the first user.

In yet another example, if an incorrect recipient receives an e-mail, any data associated with this (e.g. an e-mail from the incorrect recipient identifying the correct recipient) is used to augment the weight data (e.g. a weight value associated with the incorrect recipient can be lowered). In yet another example, if a first user inputs an e-mail address which is invalid, data associated with this (e.g. data from error logs) is used to augment the weight data (e.g. a weight value associated with the invalid e-mail address can be lowered).

Advantageously, by allowing updates to the weight data, the preferred embodiment can utilize current data in order to generate an instruction, such that an e-mail can be sent to an appropriate recipient.

It should be understood that weight data and an instruction can be represented in a variety of ways.

It should be understood, that in order to determine further inputs, the system of the preferred embodiment can utilize only locally-stored data, only remotely-stored data, or a combination of locally-stored data and remotely-stored data.

Advantageously, the present invention can be used in many applications. For example, in an environment requiring high security, wherein transmission of information to an incorrect recipient (e.g. another user outside the environment or even to another user in a sub-environment of the environment) is undesirable, the present invention allows for a mechanism to help prevent transmission of information to an incorrect recipient.

1. A system for transmitting an electronic message, wherein the electronic message is generated by a first entity utilizing an electronic messaging application, the system comprising:
an input detector for detecting a first input to the electronic message from the first entity, wherein the first input is associated with a first address of a second entity;
a weight component for determining first weight data associated with the first input; and
an instruction generator, for generating an instruction associated with transmission of the electronic message to the second entity in accordance with the first weight data.

2. A system as claimed in claim 1, in which the instruction is associated with the first address.

3. A system as claimed in claim 2 further comprising a comparator for comparing the first input with a storage component comprising data in order to derive a second input associated with a second address of a third entity.

4. A system as claimed in claim 3 wherein the comparator matches the first input to the data.

5. A system as claimed in claim 4 wherein the weight component determines second weight data associated with the second input.

6. A system as claimed in claim 5, in which the instruction generator ranks the first weight data and the second weight data in order to select one of the first weight data and the second weight data.

7. A system as claimed in claim 6, in which the instruction generator generates the instruction in accordance with the selected weight data.

8. A system as claimed in claim 7 wherein the instruction generator transmits the instruction to the electronic messaging application.

9. A system as claimed in any of claims 1-8 in which the instruction generator compares at least one of the first weight data and the second weight data with a threshold in order to generate the instruction.

10. A method for transmitting an electronic message, wherein the electronic message is generated by a first entity utilizing an electronic messaging application, the method comprising the steps of:
detecting a first input to the electronic message from the first entity, wherein the first input is associated with a first address of a second entity;
determining first weight data associated with the first input; and
generating an instruction associated with transmission of the electronic message to the second entity in accordance with the first weight data.

11. A method as claimed in claim 10, in which the instruction is associated with the first address.

12. A method as claimed in claim 11, further comprising the step of: comparing the first input with a storage component comprising data in order to derive a second input associated with a second address of a third entity.

13. A method as claimed in claim 12, in which the comparing step further comprises the step of: matching the first input to the data.

14. A method as claimed in claim 13, further comprising the step of: determining second weight data associated with the second input.

15. A method as claimed in claim 14 further comprising the step of ranking the first weight data and the second weight data in order to select one of the first weight data and the second weight data.

16. A method as claimed in claim 15, in which the instruction is generated in accordance with the selected weight data.

17. A method as claimed in claim 16 further comprising the step of transmitting the instruction to the electronic messaging application.

18. A method as claimed in any of claims 10 to 17 further comprising the step of comparing at least one of: the first weight data and the second weight data with a threshold, in order to generate the instruction.

19. A computer program product comprising computer usable media embodying computer program code that, when executed on a computer, causes the computer to control transmission of an electronic message generated by a first entity utilizing an electronic messaging application, by:
detecting a first input to the electronic message from the first entity, wherein the first input is associated with a first address of a second entity;
determining first weight data associated with the first input; and
generating an instruction associated with transmission of the electronic message to the second entity in accordance with the first weight data.
